(19) United States
(12) Patent Application Publication
(10) Pub. No.: US 2016/0316966 A1
(43) Pub. Date: Nov. 3, 2016

(54) MODULAR COOKING APPARATUS

(71) Applicant: Khosro David ILLULIAN, Los Angeles, CA (US)

(72) Inventor: Khosro David ILLULIAN, Los Angeles, CA (US)

(21) Appl. No.: 14/907,711

(22) PCT Filed: Oct. 7, 2015
(86) PCT No.: PCT/US15/54535

§ 371 Date: Jan. 26, 2016

Related U.S. Application Data
(60) Provisional application No. 62/073,570, filed on Oct. 31, 2014.

(51) Int. Cl. A47J 37/07; A47J 37/04

(52) U.S. Cl. CPC A47J 37/0786; A47J 37/0704; A47J 37/049; A47J 2037/0795

(57) ABSTRACT

A modular cooking system includes a body, a grill receiver located in an upper region of the body, a grill top resting on the grill receiver, and a charcoal holder located in a region of the body below the grill receiver. Two pairs of support arms support the charcoal holder. A threaded lever passes through the body into the interior region of the system. There is a horizontal resting on a support bracket in the interior of the system. The horizontal, the support bracket, the threaded lever, and the support arms to lift and lower the charcoal holder.

### CROSS-REFERENCE TO RELATED APPLICATION

This application claims priority on U.S. provisional patent application No. 62/073,570 filed Oct. 31, 2014, which is incorporated herein by reference in its entirety.

### FIELD AND BACKGROUND OF THE INVENTION

1. Field of the Invention

The present invention relates generally to the field of cooking devices, and, in particular, to a new and useful modular cooking apparatus which may be employed for grilling and barbequing.

2. Background of the Invention

The terms “barbeque” and “grilling” are sometimes used inter-changeably. While there is variation and overlap in terminology and method surrounding these forms of cooking, a generally-accepted difference between barbecuing and grilling is in the type of heat used: grilling is generally performed over direct heat from low-smoke fuels (with the flame contacting the meat itself), while barbecuing is usually performed over indirect heat from high-smoke fuels (with the flame not contacting the meat directly).

Another difference concerns the time of exposure and intensity of the heat. Grilling involves cooking over intense heat (500° or more) for relatively short periods of time (an hour or less). Barbecuing involves cooking over low heat (225° or less), with smoke, and for long periods of time (usually longer than one hour).

One problem faced in both grilling and barbequing is that ashes periodically fall into the bottom of the cooking apparatus, forcing the user to scoop out the ashes, vacuum them or otherwise clean the bottom with great difficulty. The present invention addresses this problem.

Another problem is faced in shipping and transporting cooking devices, particularly those with legs. The present invention allows for convenient handling, shipping and transportation. The present invention simplifies the disassembling and storing process. A further, related, difficulty faced by commercial entities, as well as by end users, is the amount of space taken up by typical cooking apparatuses.

U.S. Pat. No. 5,579,755 to Johnston teaches a grill assembly having a plurality of legs which are partially fastened together at their lower ends by a shelf and secured at their upper ends by a grill containment surface. The upper grill containment surface has a rectangular middle section with a portion removed for receiving a grill and at least one side shelf extending towards the front of the assembly. However, this assembly does not have an adequate ash collection function. It is also bulky and presents shipping and storage problems to the user.

U.S. Pat. No. 6,038,965 to Thorndyke teaches a portable barbecue grill apparatus having barbecuing, baking, roasting, and pan broiling functions. The reference teaches that the grill apparatus may be provided with an extendable rear lid having a rotisserie attached to a base. The lid and base each contain heating elements associated one or two portable propane tanks.

The apparatus taught therein is low to the ground when used without a table or other surface. This limits the user to locations where a raised surface is located. Otherwise, it forces the user to purchase and carry a separate product, such as a table, both increasing cost and reducing convenience. In the absence of a table or raised surface, the user is forced to place the product on the ground and kneel, squat or bend over the device in order to cook. In addition, the known problems associated with ash removal are not addressed at all by this reference.

Thus, there is a need in the art for a device which addresses the problems outlined above.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### SUMMARY OF THE INVENTION

A modular cooking apparatus and associated cooking method is disclosed herein.

It is an object of the present invention to provide a portable and versatile cooking apparatus.

It is a further object to provide a cooking apparatus which is convenient and is easy to clean and maintain.

The cooking apparatus disclosed herein is a modular cooking system which includes a body, a grill receiver located in an upper region of the body, a grill top resting on the grill receiver, and a charcoal holder located in a region of the body below the grill receiver. Two pairs of support arms are connected to and support the charcoal holder. There is a horizontal bar resting on a support bracket and cooperating with the support arms to lift and lower the charcoal holder.

The charcoal holder, the threaded lever, the support arms, the support bracket, and the horizontal bar are oriented such that, when the threaded lever is turned in one direction the charcoal holder moves in a generally upwards direction and when the threaded lever is turned in the opposite direction the charcoal holder moves in a generally downwards direction.

In one embodiment, there is a plate positioned on the horizontal bar. A threaded lever passes through an opening in the body and is designed and positioned to push against the plate.

In another embodiment, the threaded lever does not push against a plate on the horizontal bar. Rather, the threaded lever is provided with a ring, from which extends a perpendicular extension. The perpendicular extension extends through a side opening in a housing. The housing is positioned to press up against the underside of the horizontal bar. As the threaded lever extends forward into the interior of the body, the perpendicular extension moves along a length of the side opening of the housing. This causes the housing to push up against the underside of the horizontal bar. The upward movement of horizontal bar causes the parallelogram arms to lift up. With the lifting of the parallelogram arms, the charcoal tray is lifted up.

### BRIEF DESCRIPTION OF THE DRAWINGS

In the drawings:

FIG. 1 is a schematic drawing of the modular cooking system according to the present invention;

FIG. 2 is a top, side perspective view of a first embodiment of the present modular cooking system with the side trays and the grill top removed, and the ash collector pulled out;

FIG. 3 is top, front perspective view thereof;

FIG. 4 is a close-up view of the view shown in FIG. 3;

FIG. 5 is a top, side perspective view of the first embodiment showing the charcoal holder resting above the ash collector;

FIG. 6 is a top, side view thereof showing the ash collection tray pulled out;

FIG. 7A is a close-up front view thereof showing the side tray separated from the body; FIG. 7B is a top, side perspective view thereof showing the manner of connecting the side tray to the body; FIG. 7C shows the side tray connected to the body;

FIG. 8 is a close-up, top, perspective view thereof showing the relationship among the handle, the threaded lever, the parallelogram arms, the plate, the horizontal, and the charcoal holder;

FIG. 9 is a close-up, top, perspective view thereof showing the threaded lever pushing against the plate;

FIG. 10 is a close-up, top, perspective view thereof showing the relationship among the brackets, the parallelogram arms, the plate, the horizontal, and the charcoal holder;

FIG. 11 is a close-up, top, perspective view thereof showing the handle and the threaded lever;

FIG. 12 is a top, right perspective view of a second embodiment of the present modular cooking system;

FIG. 13 is a top, left perspective view thereof;

FIG. 14 is a close-up, top view thereof showing the threaded lever;

FIG. 15 is a close-up, top, perspective view thereof showing the relationship among the threaded lever, the housing, the bracket, the parallelogram arms, the horizontal, and the charcoal holder;

FIG. 16 is a close-up, top, perspective view thereof showing the relationship among the first bracket, the parallelogram arms, and the charcoal holder;

FIG. 17 is a partial front view thereof, showing the handle and a side tray folded down;

FIG. 18A is a close-up, top, perspective view thereof showing the horizontal resting on the second bracket; and

FIG. 18B is a close-up, top, perspective view thereof showing the horizontal after being pressed up from the second bracket by the housing.

### DESCRIPTION OF THE PREFERRED EMBODIMENTS

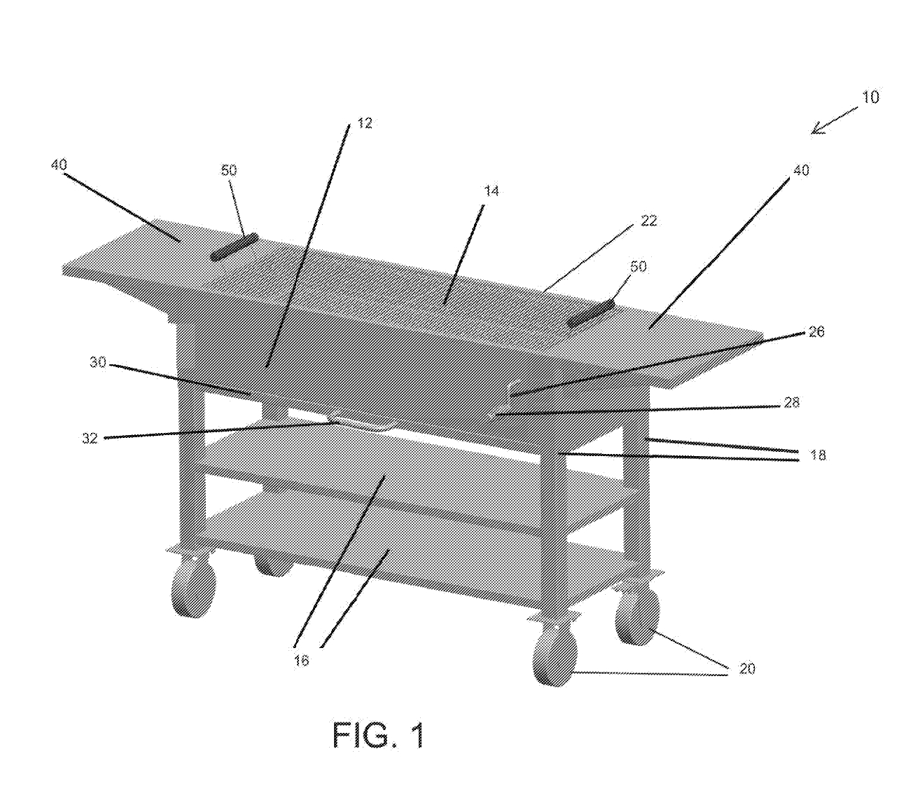

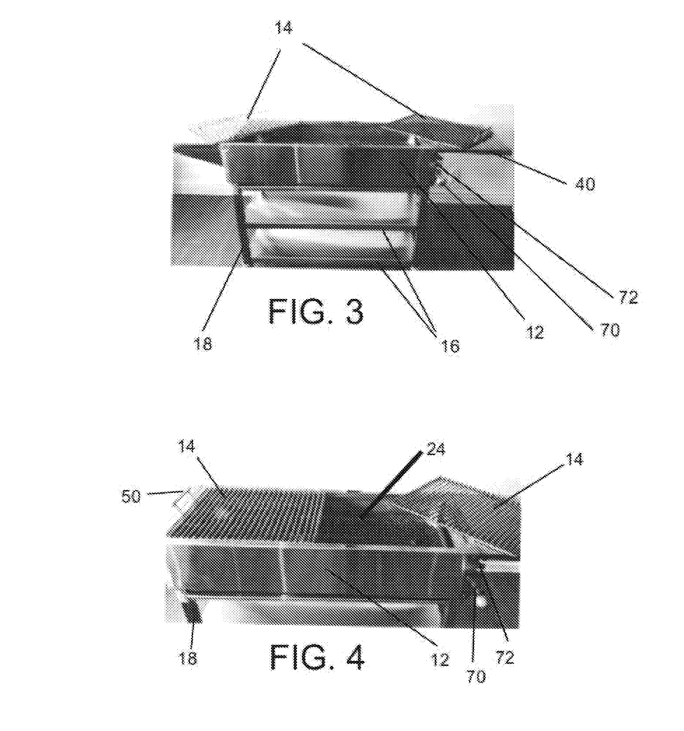

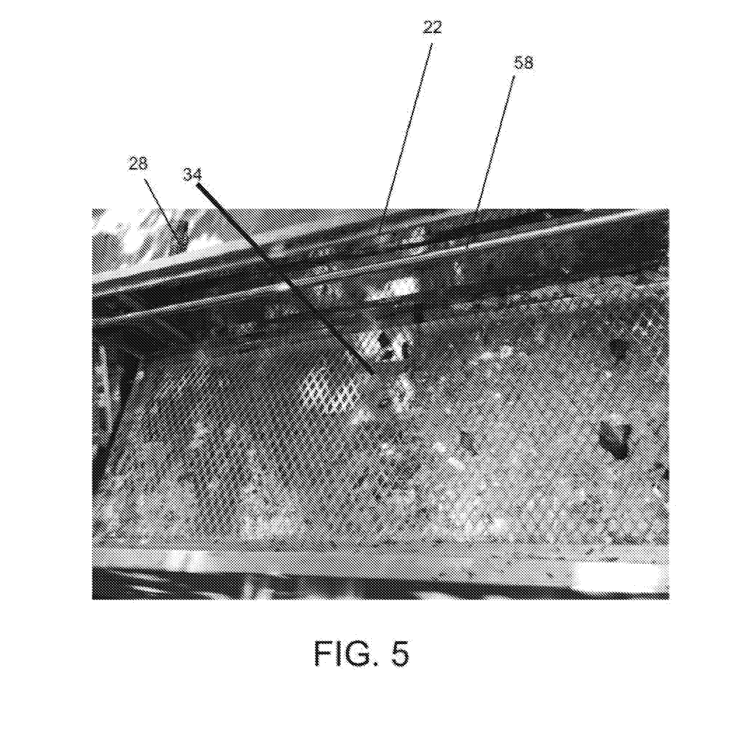

Referring now to the drawings, FIGS. 1-4 show an embodiment of the modular cooking system 10 which has a body 12, a grill top 14, shelves 16 and legs 18. The legs may include casters 20 of different sizes. The grill top 14 may be a single-piece as shown in FIG. 1, or a multi-piece, as shown in FIGS. 3 and 4. The modular cooking system 10 has a length and width, each of which can be selected according to the needs of the user or the demands of the marketplace. The body 12 is typically a square or rectangular box shape that can vary in size. However, it is within the scope of the invention for the body 12 to be of any convenient shape known to those of skill in the art, including, but not limited to, round or oblong.

As also shown in FIGS. 1-4, the body 12 further includes a grill receiver 22 on which the grill top 14 is disposed. The grill receiver 22 can accommodate a one-piece grill top 14 or a multi-piece grill top 14. The grill top 14 optionally includes at least one handle 60. It is within the scope of the invention for the handles or handles 60 to be removable.

One or more parts of the grill top 14 can slide on or off the modular cooking system 10 depending on whether the user wants to charcoal-grill the food or use skewers to barbecue the food.

That is, the present invention allows for cooking on the grill top 14 or using skewers with the grill top 14 removed. This provides for flexibility to the user regarding the distance between the food and the heat source.

As well, the present invention is adapted to allow for the use of numerous skewers simultaneously.

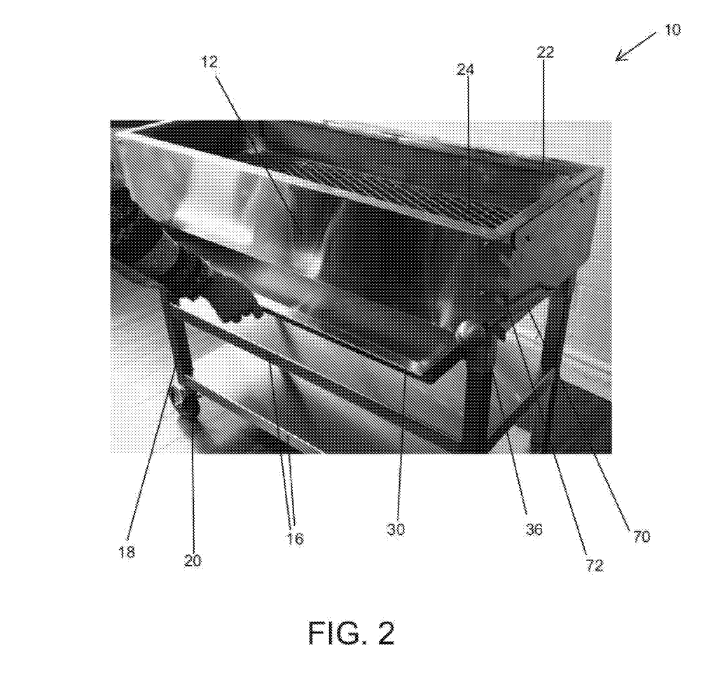

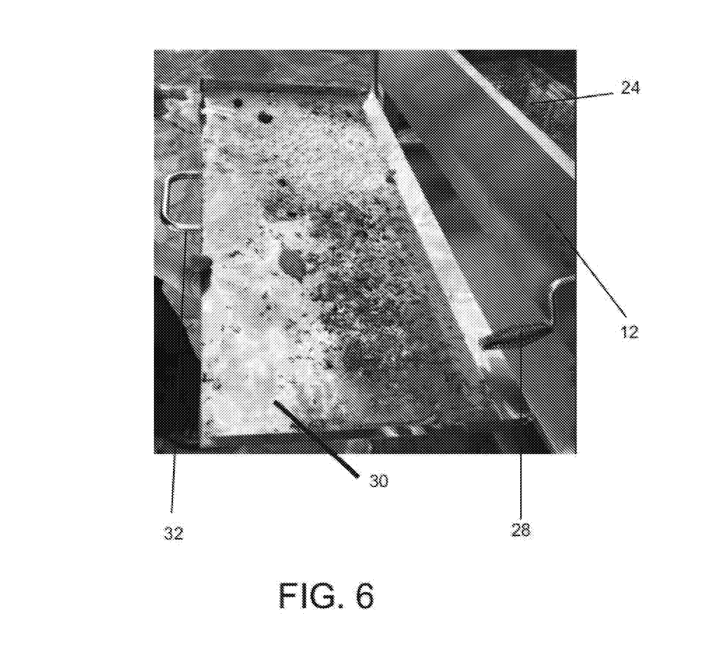

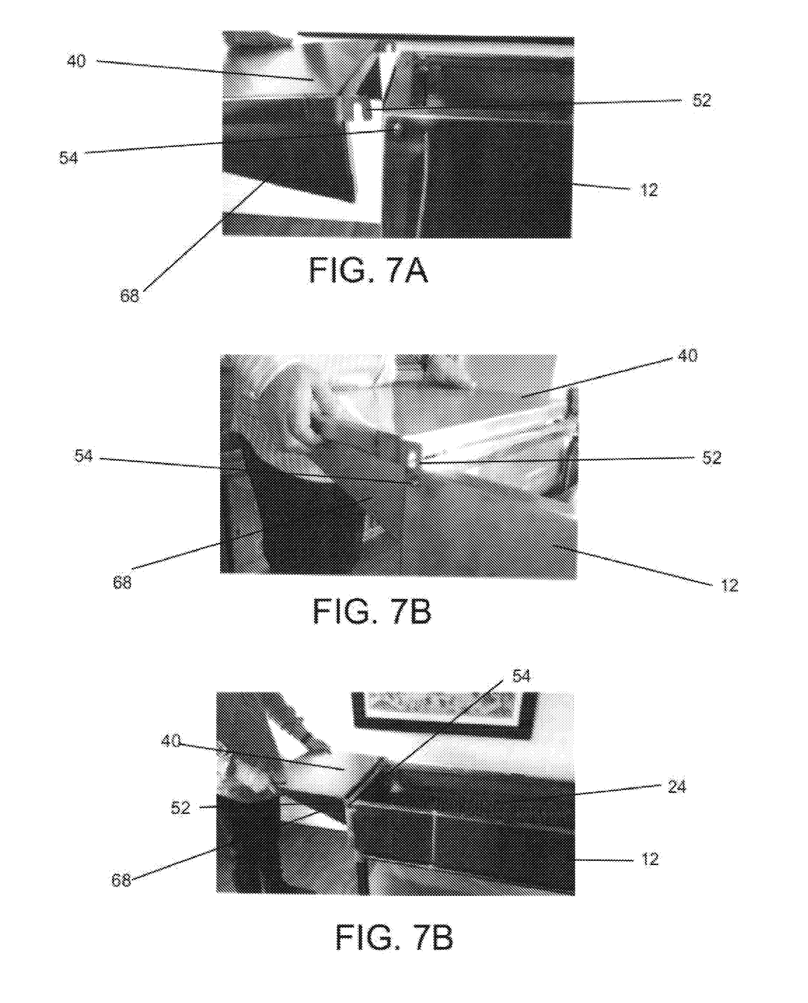

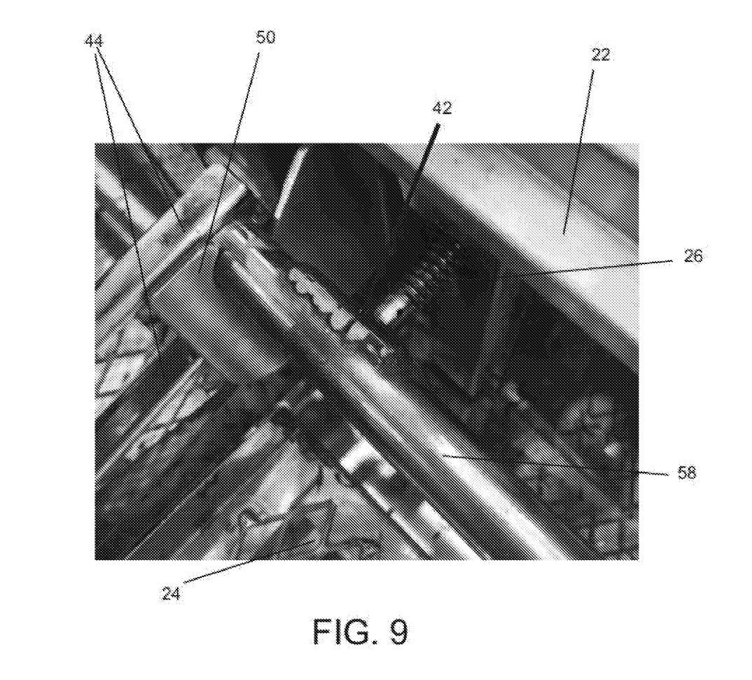

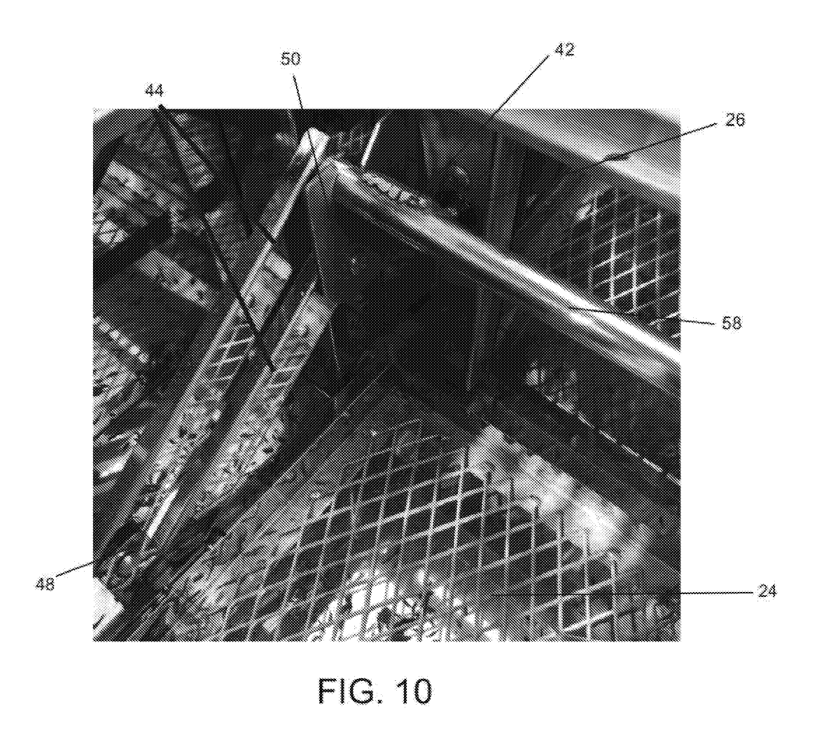

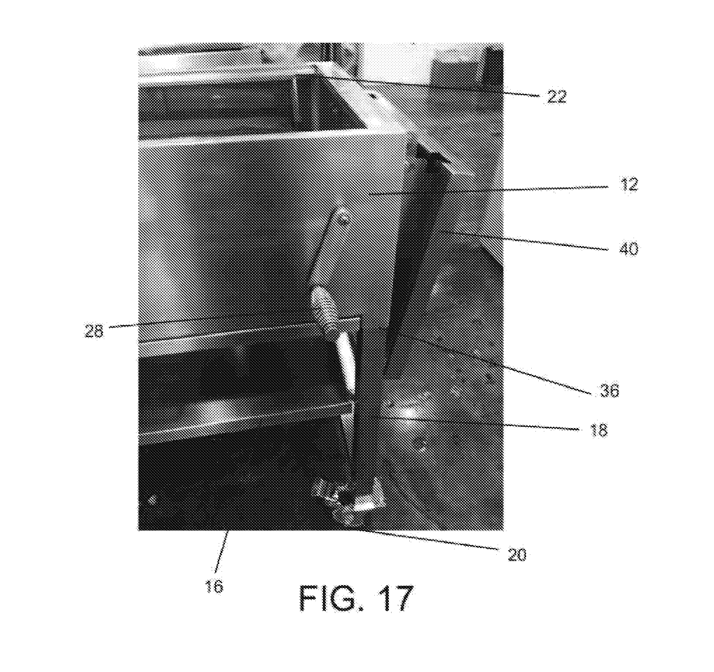

As best shown in FIGS. 2, 4-10, 16, 18A and 18B, the body 12 also includes a movable charcoal holder 24, typically a grated metal tray, for holding charcoal. The position of the charcoal holder 24 may be manually adjusted by a threaded lever 26, as discussed in detail below. Thus the threaded lever 26 functions to adjust the distance between the charcoal holder 24 (and, therefore, the charcoal heat) and the food on the grill 14 for faster or slower cooking. The threaded lever 26 is typically provided with a handle 28. It is within the scope of the invention for the threaded lever 26 and handle 28 to extend from either the front or the back of the body 12.

The threaded lever 26 can be rotated inwards or outwards relative to the body 12. In one embodiment, rotating the lever handle 28 in one direction causes the threaded lever 26 to push against a plate 42 disposed on a horizontal bar 58. The plate 42 and the horizontal bar 58 cooperate with parallelogram arms 44 that support the grated charcoal holder 24, thereby raising the grated charcoal holder 24. Rotating the lever handle 28 in the opposite direction causes the threaded lever 26 to retreat from the plate 42, thereby lowering the grated charcoal holder 24. Thus, the position of the grated charcoal holder 24 is variable and depends of the position of the threaded lever 26.

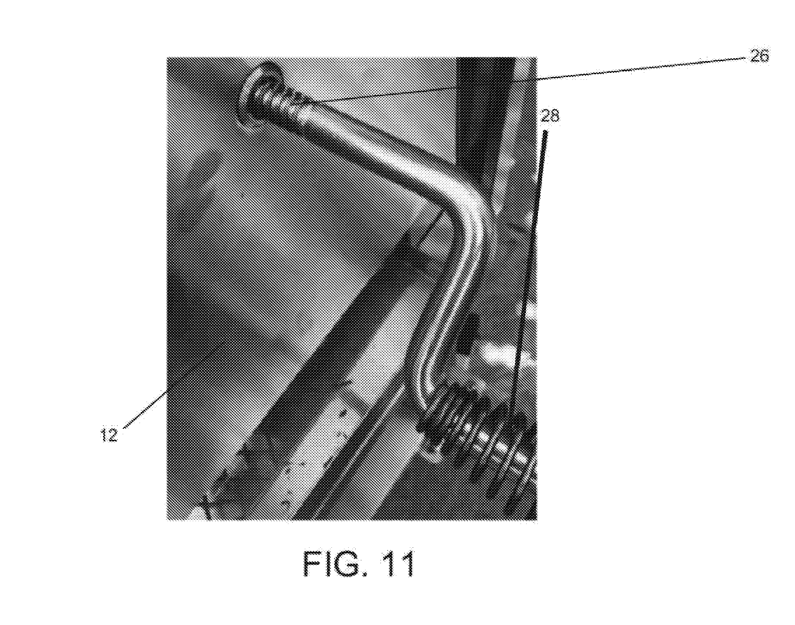

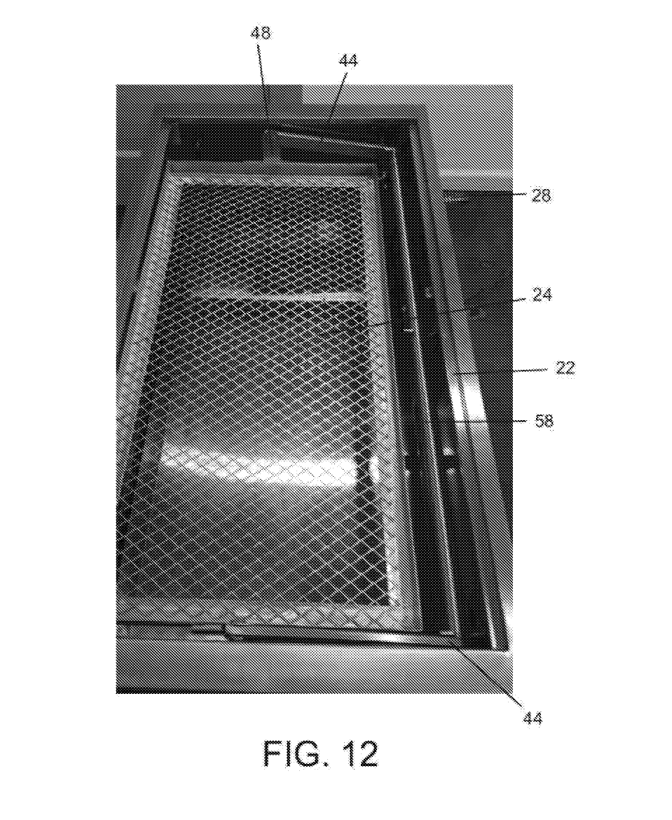

As best shown in FIG. 10, the grated charcoal holder 24 is connected to parallelogram arms 44 via a first bracket 48. The parallelogram arms 44 are themselves supported by first and second brackets 48, 50 and a horizontal bar 58. The horizontal bar 58 is supported on second bracket 50.

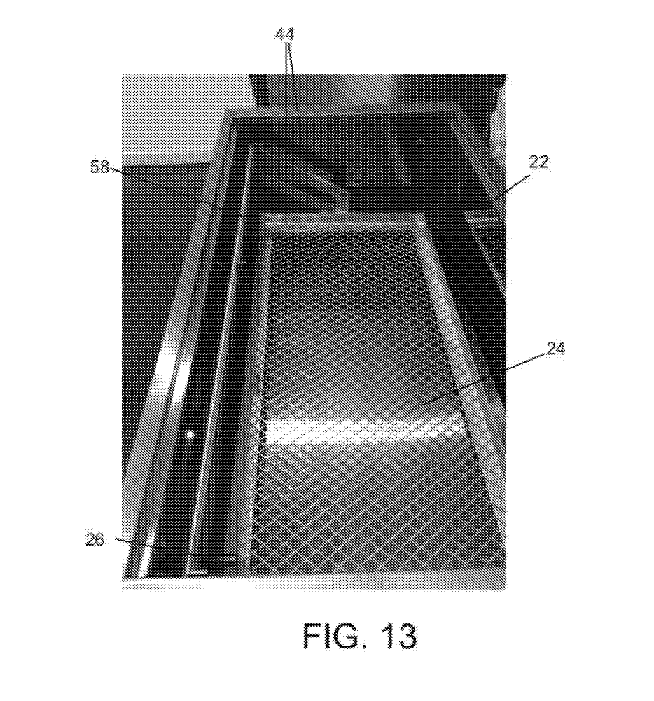

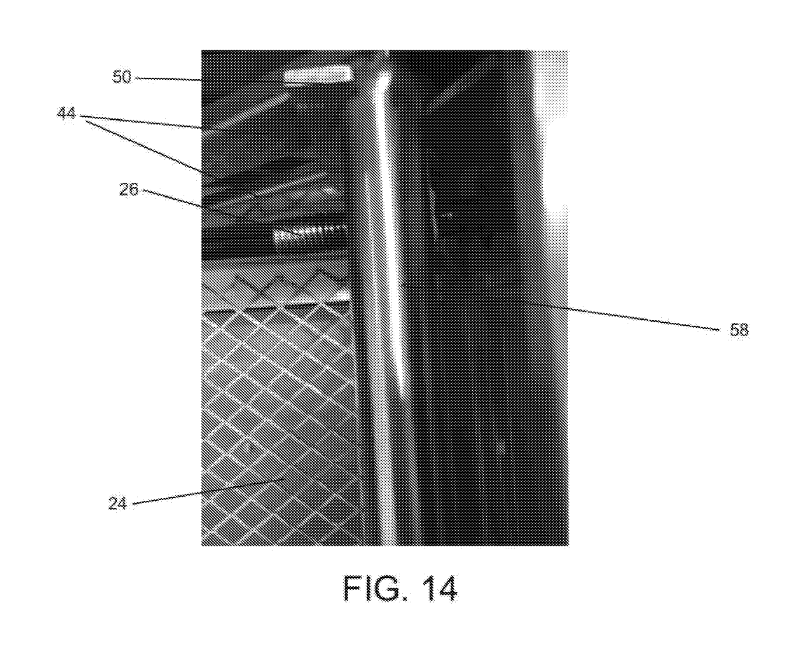

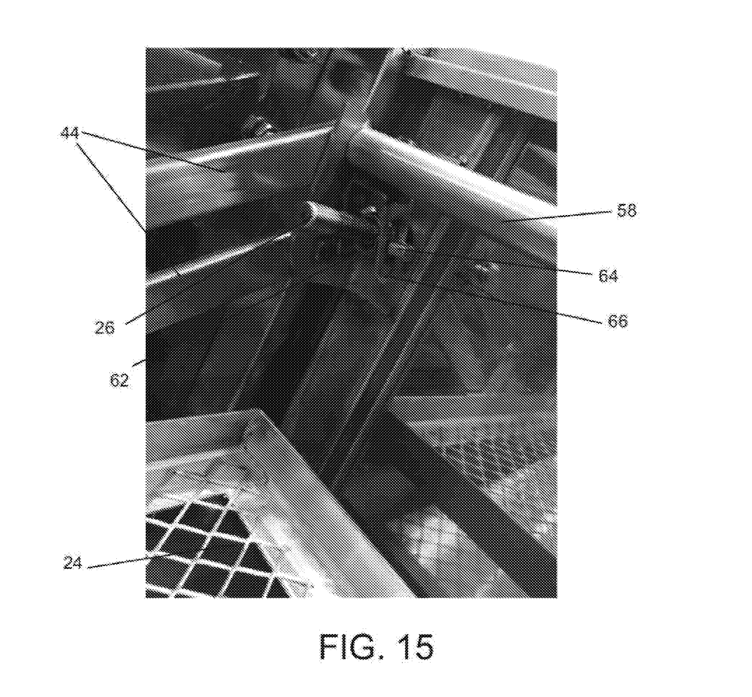

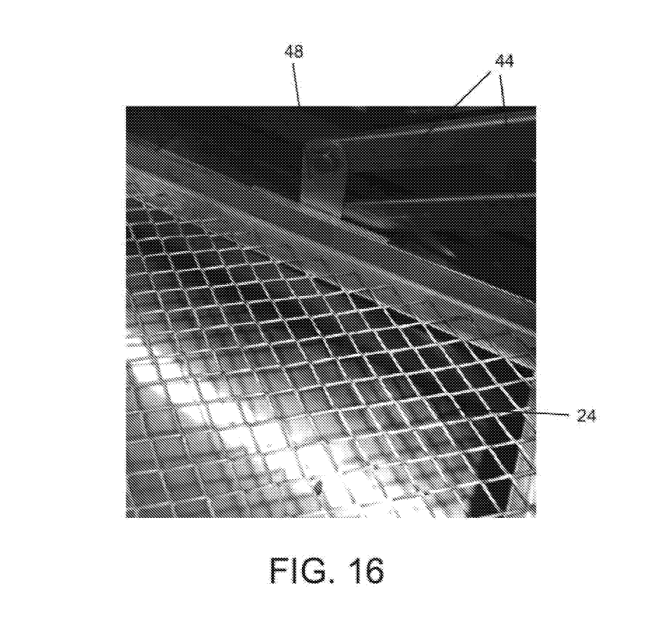

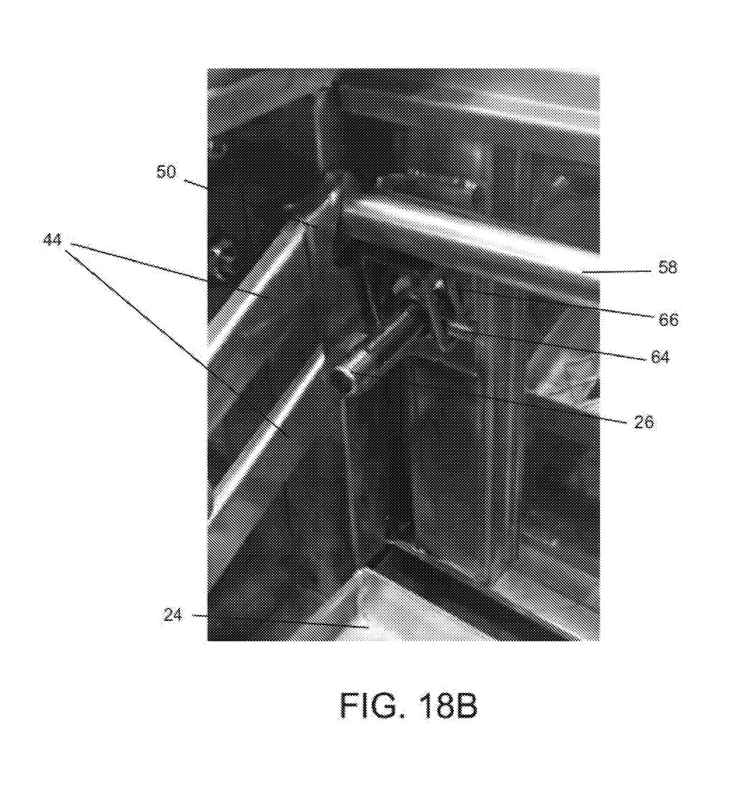

FIGS. 12-18B show a further embodiment of the invention in which the threaded lever 26 does not push directly against a plate 42. Rather, in this embodiment, the threaded lever 26 is provided with a ring 62, from which extends a perpendicular extension 64. The perpendicular extension 64 extends through a side opening in a housing 66. The housing 66 is positioned to press up against the underside of the horizontal (FIG. 18A). As the threaded lever 26 extends forward into the interior of the body 12, the perpendicular extension 64 moves along a length of the side opening of the housing 66. This causes the housing 66 to push up against the underside of the horizontal bar 58. The upward movement of horizontal bar 58 causes the parallelogram arms 44 to lift up (FIG. 18B). With the lifting of the parallelogram arms 44, the charcoal tray 24 is lifted up. It is within the scope of the invention for the perpendicular extension 64 to extend directly from the threaded lever 26, that is, without the need for a ring 62.

As shown in FIGS. 2-4, in certain embodiments, instead of the threaded lever 26, there is provided an external lever 70, supported on a toothed bracket 72 for manually raising and lowering the charcoal holder 24.

As best seen in FIGS. 1, 2 and 6, situated below the body 12 is a removable ash collector 30, for capturing spent charcoal ash from the charcoal holder 24. The ash collector 30 is optionally provided with a handle 32. The removable ash collector 30 slides into and out of the body 12, below the charcoal holder 24, such that a user can easily dispose of the ashes. The ashes are prevented from falling. Otherwise, the user would need to vacuum them or otherwise remove them with difficulty.

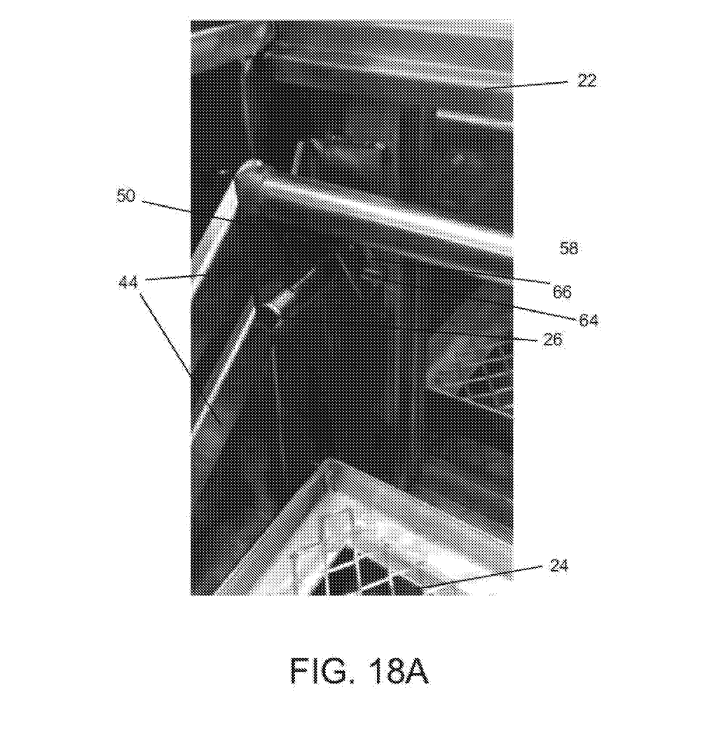

As best seen in FIGS. 2 and 17, extending from the bottom side of the body 12 are one or more (e.g., four) built-in and properly-sized openings 36 to easily receive the legs 18 in and withdraw them out of the body 12 without any tools or screws. This feature enables the modular cooking system 10 to be much more compact for commercial shipping and handling. It also enables end consumers to transport the system 10 to various locations such as to the beach, a picnic site, or a camping site. This feature further simplifies disassembling and storing the modular cooking system 10. The dismountable features of the modular cooking system 10 minimize the space required for commercial entities to hold and sell the modular cooking system 10 as well as for consumers to store the system 10 once purchased, if desired. The simplicity of assembly also reduces the time, cost and expertise required for usage.

As noted above, the removable legs 18 are configured to optionally accept casters 20 of different sizes. These casters 20 further enhance the convenience and portability of the modular cooking system 10 by allowing the user to easily roll the modular cooking system 10 to any point on a particular site (e.g., a different location on a backyard) in a convenient and practical manner. This is especially useful in cases where the modular cooking system 10 must be moved to better lighted or ventilated areas. The casters 20 are removable for more convenient shipping and storage.

As shown in FIGS. 1-4, the modular cooking system 10 further includes one or more removable and adjustable shelves 16 located below the ash collector 30 for facilitating the storage, handling and usage of accessories, raw and cooked food, cookware and utensils. The removable shelves 16 can be adjusted in height to be conveniently located for the user.

As shown in FIGS. 1, 3, 4, 7A-7C and 17 the modular cooking system 10 further includes one or more side trays 40. The side trays 40 are useful for several purposes, including holding food (raw or cooked), cookware, and utensils. The side trays 40 can also be used to support, for example, a lamp to illuminate the modular cooking system 10 or a fan to expedite the lighting of the charcoal.

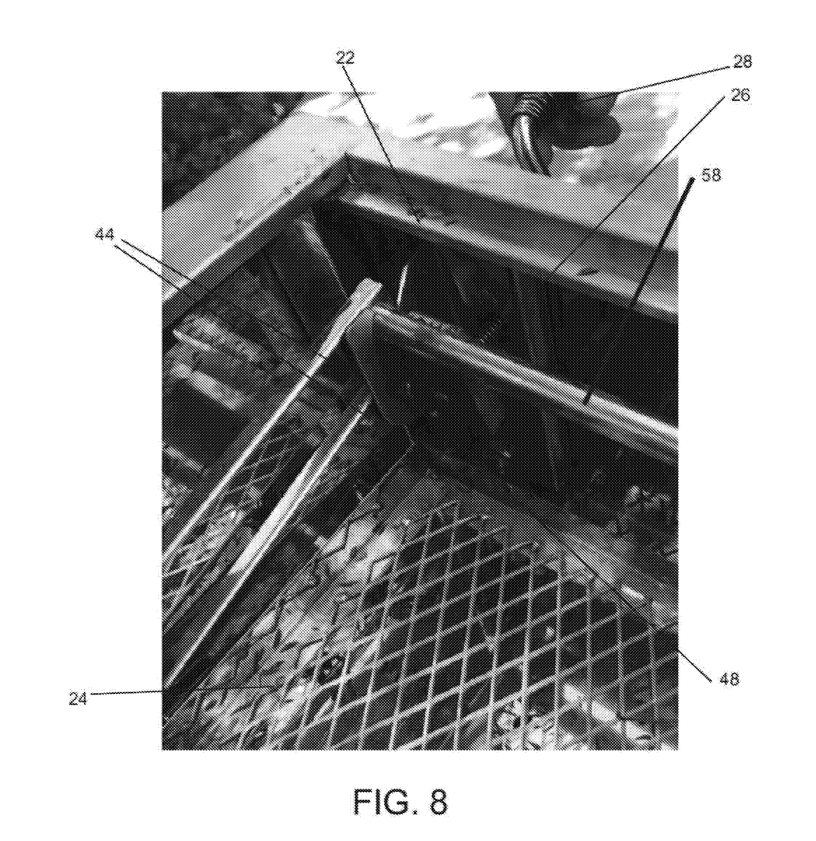

As shown in FIGS. 7A-7C, in certain embodiments, the side trays 40 can be removed for ease of use and portability. In these embodiments, the side trays 40 are provided with U-shaped grooves 52 at one end. These U-shaped grooves 52 rest on receiving extensions 54 provided on the main body 12. In these embodiments, the side trays 40 may be provided with buttresses 68 for supporting the weight of objects placed on the side trays 40.

As best seen in FIG. 17, in certain embodiments, the side trays 40 are hinged to the body 12 and can be folded down or up.

Thus, not only is it within the scope of the invention for the side trays 40 to be foldable down or up, but they may also be easily removed and replaced without tools. These features are useful for reducing the form factor of the modular cooking system 10 to optimize shipping and reduce space requirements during storage.

Embodiments of the present modular cooking system 10 can be made from any convenient material known to those of skill in the art, including but not limited to any metal, including but not limited to, stainless steel, aluminum, iron, or combinations thereof.

Those skilled in the art will appreciate that various adaptations and modifications of the above-described embodiments can be configured without departing from the scope and spirit of the present invention. Therefore, it is to be understood that, within the scope of the embodiments, the modular cooking system 10 may be practiced other than as specifically described herein.

Thus, while a specific embodiment of the invention has been shown and described in detail to illustrate the application of the principles of the invention, it will be understood that the invention may be embodied otherwise without departing from such principles.

What is claimed is:

1. A modular cooking system (10), comprising:
a body (12);
a grill receiver disposed in an upper region of the body (12);
a grill top (14) resting on the grill receiver (22);
a heat source holder (24) disposed in a region of the body (12) below the grill receiver (22);
at least one pair of support arms (44) adapted to support the heat source holder (24), the pair of support arms (44) and the heat source holder (24) being connected by at least a first support bracket (48);
a bar (58) resting on a second support bracket (50);
a plate (42) disposed on the bar (58); and
a threaded lever (26) disposed through the body (12), the threaded lever (26) adapted to push against the plate (42),
wherein the heat source holder (24), the threaded lever (26), the support arms (44), the first support bracket (48), the second support bracket (58), the bar (58), and the plate (42) are oriented such that, when the threaded lever (26) is turned in a first direction, the heat source holder (24) moves in a generally upward direction and when the threaded lever (26) is turned in a second direction the heart source holder (24) moves in a generally downward direction.

2. The modular cooking system (10) according to claim 1, wherein the grill top (14) is a multi-piece grill top (14).

3. The modular cooking system (10) according to claim 1, wherein the grill top (14) further comprises at least one handle (60).

4. The modular cooking system (10) according to claim 1, further comprising a handle (28) at an end of the threaded lever (26).

5. The modular cooking system (10) according to claim 1, further comprising at least one side shelf (40) connected to a side of the body (12).

6. The modular cooking system (10) according to claim 5, wherein the at least one side shelf (40) is hingedly connected to the side of the body (12).

7. The modular cooking system (10) according to claim 6, wherein the at least one side shelf (40) may be folded up.

8. The modular cooking system (10) according to claim 6, wherein the at least one side shelf (40) may be folded down.

9. The modular cooking system (10) according to claim 5, wherein the at least one side shelf (40) is removably connected to the side of the body (12).

10. The modular cooking system (10) according to claim 9, wherein the body (12) has a side shelf-receiving projection (54).

11. The modular cooking system (10) according to claim 10, wherein the at least one side shelf defines a groove (52) at end thereof, the groove (52) being adapted to rest on the side shelf-receiving projection (54).

12. The modular cooking system (10) according to claim 1, further comprising a collection tray (30) below the heat source holder (24).

13. The modular cooking system (10) according to claim 1, further comprising at least one shelf (16) below the body (12).

14. The modular cooking system (10) according to claim 13, wherein the at least one shelf (16) is removable.

15. The modular cooking system (10) according to claim 1, wherein the body (12) defines a plurality of leg-receiving openings (36) on an underside thereof.

16. The modular cooking system (10) according to claim 15, further comprising a plurality of legs (18) disposed within the leg-receiving openings (36).

17. The modular cooking system (10) according to claim 16, wherein each of said legs (18) is provided with a caster (20) at an end thereof.

18. A modular cooking system (10), comprising:
a body (12);
a grill receiver disposed in an upper region of the body (12);
a grill top (14) resting on the grill receiver (22);
a heat source holder (24) disposed in a region of the body (12) below the grill receiver (22);
at least one pair of support arms (44) adapted to support the heat source holder (24), the pair of support arms (44) and the heat source holder (24) being connected by at least a first support bracket (48);
a bar (58) resting on a second support bracket (50);
a threaded lever (26) disposed through the body (12);
a housing (66) surrounding the threaded lever, the housing (66) defining an opening along a lateral side thereof; and
a perpendicular member (64) extending from the threaded lever (26), the perpendicular member (64) extending through the opening in the housing (66),
wherein the heat source holder (24), the threaded lever (26), the perpendicular member (64), the housing (66), the bar (58), the support arms (44), the first support bracket (48), and the second support bracket (58) are oriented such that, when the threaded lever (26) is turned in a first direction, the heat source holder (24) moves in a generally upward direction and when the threaded lever (26) is turned in a second direction the heat source holder (24) moves in a generally downward direction.

19. The modular cooking system (10) according to claim 20, wherein the perpendicular member (64) is oriented to push against the housing (66).

20. The modular cooking system (10) according to claim 20, wherein the housing (66) is oriented to push against the bar (58).

21. The modular cooking system (10) according to claim 20, wherein the bar (58) is oriented to lift up the support arms (44).

22. The modular cooking system (10) according to claim 20, wherein the support arms (44) and the first support bracket (48) are oriented to lift up the heat source holder (24).
